(19) United States
(12) Patent Application Publication
(10) Pub. No.: US 2025/0372858 A1
(43) Pub. Date: Dec. 4, 2025

(54) PARALLEL COUPLED LINE COUPLER SYSTEMS AND METHODS

(71) Applicant: pSemi Corporation, San Diego, CA (US)

(72) Inventors: Vijay Katta, San Diego, CA (US); Emre Ayranci, San Diego, CA (US)

(21) Appl. No.: 18/731,165

(22) Filed: May 31, 2024

(51) Int. Cl. H01P 5/18

(52) U.S. Cl. CPC H01P 5/184

(57) ABSTRACT

Parallel coupled line coupler systems and methods are provided. In one example, a coupled line coupler includes an input port, an output port, a coupled port, and an isolated port. The coupled line coupler further includes a main line coupled between the input port and the output port. The coupled line coupler further includes a first and a second coupled line displaced from the main line. The coupled line coupler further includes a first line coupled to the first coupled line, the second coupled line, and the isolated port. The coupled line coupler further includes a second line coupled to the first coupled line, the second coupled line, and the coupled port. Related systems and methods are also provided.

### TECHNICAL FIELD

The present disclosure relates generally to couplers, and more particularly for example, to parallel coupled line coupler systems and methods.

### BACKGROUND

Modern electronic devices may incorporate electronic components designed to operate within certain parameters. Couplers may provide power received at one port to one or more other ports. Couplers may be implemented within and/or coupled to electronic devices to provide appropriate power to various components of the electronic devices, separate/divide power propagating within the electronic devices (e.g., for monitoring purposes) into multiple paths, among other applications.

### SUMMARY

In one or more embodiments, a coupled line coupler includes an input port, an output port, a coupled port, and an isolated port. The coupled line coupler further includes a main line coupled between the input port and the output port. The coupled line coupler further includes a first coupled line displaced from the main line. The coupled line coupler further includes a second coupled line displaced from the main line. The coupled line coupler further includes a first line coupled to the first coupled line, the second coupled line, and the isolated port. The coupled line coupler further includes a second line coupled to the first coupled line, the second coupled line, and the coupled port.

In one or more embodiments, a method includes providing a signal to a main line of a coupled line coupler. The main line is coupled between an input port of the coupled line coupler and an output port of the coupled line coupler. The method further includes propagating the signal through the main line to provide a first portion of the signal at the output port. The method further includes coupling a second portion of the signal to a coupled port of the coupled line coupler via a first coupled line, a second coupled line, and a line of the coupled line coupler. The first and second coupled lines are displaced from the main line. The line is coupled to the first coupled line, the second coupled line, and the coupled port.

The scope of the disclosure is defined by the claims, which are incorporated into this section by reference. A more complete understanding of embodiments of the present disclosure will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates an example system in which a parallel coupled line coupler may be implemented in accordance with one or more embodiments of the present disclosure.

FIG. 2 illustrates an example transmitter system with a parallel coupled line coupler in accordance with one or more embodiments of the present disclosure.

FIG. 3 illustrates a view of an example parallel coupled line coupler in accordance with one or more embodiments of the present disclosure.

FIG. 4A illustrates a view of an example transmitter circuit having a parallel coupled line coupler in accordance with one or more embodiments of the present disclosure.

FIGS. 4B, 4C, and 4D each illustrate a perspective view of the transmitter circuit of FIG. 4A (or portion thereof) in accordance with one or more embodiments of the present disclosure.

FIG. 4E illustrates a cross-sectional view of an attachment element coupling a coupled transmission line to a transmission line of the parallel coupled line coupler of FIG. 4A in accordance with one or more embodiments.

FIG. 5A illustrates an example relationship between a directivity associated with the parallel coupled line coupler of FIG. 4A and frequency in accordance with one or more embodiments of the present disclosure.

FIG. 5B illustrates an example relationship between a coupling factor associated with the parallel coupled line coupler of FIG. 4A and frequency in accordance with one or more embodiments of the present disclosure.

FIG. 5C illustrates an example relationship between an insertion loss associated with the parallel coupled line coupler of FIG. 4A and frequency in accordance with one or more embodiments of the present disclosure.

FIG. 5D illustrates an example relationship between a return loss associated with the parallel coupled line coupler of FIG. 4A and frequency in accordance with one or more embodiments of the present disclosure.

FIG. 5E illustrates an example Smith chart associated with the parallel coupled line coupler of FIG. 4A in accordance with one or more embodiments of the present disclosure.

FIG. 6 illustrates a view of an example parallel coupled line coupler in accordance with one or more embodiments of the present disclosure.

FIG. 7 illustrates a view of another example parallel coupled line coupler in accordance with one or more embodiments of the present disclosure.

FIGS. 8A and 8B illustrate a first configuration and a second configuration, respectively, of a parallel coupled line coupler in accordance with one or more embodiments of the present disclosure.

FIG. 9 illustrates an example layout for implementing the parallel coupled line coupler of FIGS. 8A and 8B in accordance with one or more embodiments of the present disclosure.

FIG. 10 illustrates a flow diagram of an example process for designing an integrated circuit having a parallel coupled line coupler in accordance with one or more embodiments of the present disclosure.

FIG. 11 illustrates a flow diagram of an example process of operating a parallel coupled line coupler in accordance with one or more embodiments of the present disclosure.

Embodiments of the present disclosure and their advantages are best understood by referring to the detailed description that follows. It is noted that sizes of various components and distances between these components are not drawn to scale in the figures. It should be appreciated that like reference numerals are used to identify like elements illustrated in one or more of the figures.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology. One or more embodiments of the subject disclosure are illustrated by and/or described in connection with one or more figures and are set forth in the claims.

In one or more embodiments, parallel coupled line couplers are provided. In one embodiment, a parallel coupled line coupler has an input port, an output port, a coupled port, and an isolated port. The parallel coupled line coupler may include a main transmission line and two coupled transmission lines displaced from the main transmission line. In some cases, the two coupled transmission lines may be parallel to and displaced on opposite sides of the main transmission line. As one example, the two coupled transmission lines may be substantially/nominally equidistant from the main transmission line. The main transmission line may be coupled between the input port and the output port. The parallel coupled line coupler may also include a first transmission line that may be coupled to a first end of the coupled transmission lines and to the coupled port, and a second transmission line that may be coupled to a second end of the coupled transmission lines and to the isolated port. The coupled transmission lines and the first and second transmission lines do not physically contact the main transmission line. Each of the first and second transmission lines may be coupled to an end of the coupled transmission lines using attachment elements (e.g., also referred to as connector elements, connectors, or vias). In an aspect, a transmission line may be referred to simply as a line.

The parallel coupled line coupler may receive a signal at the input port. A portion of the signal received at the input port propagates through the main line to the output port. A portion of the signal propagating through the main line may couple into the coupled lines and to the coupled port and the isolated port via the first line and the second line, respectively. The isolated port is designed to be isolated and thus receive negligible power (e.g., ideally/nominally zero power). The parallel coupled line coupler may be used to provide appropriate power to various components of an electronic device, separate/divide power propagating within an electronic device (e.g., for testing/monitoring purposes) into multiple paths, and/or other applications.

The parallel coupled line couplers (and components thereof) may be of an appropriate shape, size (e.g., dimensions), and/or material system to achieve desired characteristics. Such characteristics may include performance characteristics (e.g., also referred to as coupler/coupling characteristics), such as a coupling factor, a directivity, an isolation, an insertion loss, and a return loss, and/or other characteristics/considerations, such as a coupler size (e.g., space and/or cost/amount of material to implement the coupler may be design constraints), manufacturing complexity/cost, and so forth. Various performance characteristics generally relate a power associated with one port of the parallel coupled line coupler with another port of the parallel coupled line coupler. For example, the coupling factor may be based on a ratio of an input power provided to the input port and a power received at the coupled port (e.g., indicative of a portion of the input power that is coupled to the coupled port).

In some aspects, the various transmission lines are formed of conductive material and may be referred to as conductive transmission lines or simply conductive lines. The conductive material may be selected from materials associated with a given manufacturing process of the parallel coupled line coupler. As an example, the lines may be formed of metal, such as copper. In some cases, the attachment elements may also be formed of conductive material, such as copper. As non-limiting example shapes, the parallel coupled line couplers may have a straight line, an L-shape, and/or a serpentine shape, although generally any shape may be used to meet desired characteristics. In this regard, for an L-shaped parallel coupled line coupler, the coupled lines may extend and remain substantially parallel with the main line along the L-shaped length of the parallel coupled line coupler.

In some embodiments, parallel coupled line couplers may have a selectable size (e.g., selectable length, selectable area). The size of such parallel coupled line couplers may be selected to allow operation in multiple frequency bands and/or to provide different performance characteristics in association with operation in a single frequency band. In some aspects, accommodation of multiple frequency bands by a single parallel coupled line coupler having a selectable size is generally associated with savings (e.g., chip real estate savings) relative to a case in which multiple couplers are used to handle the different frequency bands. In some aspects, such parallel coupled line couplers may include multiple sections and may be referred to as multi-section parallel coupled line couplers. Each section includes a main transmission line, coupled transmission line in parallel with the main transmission line, and transmission lines that connect the coupled transmission lines together. Each section may be selectively coupled (e.g., using one or more switches that can be closed/on or open/off) to one or more other sections. A state (e.g., closed/on or open/off state) of each switch may be based on a control signal applied to the switch. In an aspect, control signals for the switches may be provided by a logic device. In some cases, a switch may be implemented using a transistor, with a control signal (e.g., driven to an appropriate voltage level) provided to a gate of the transistor.

In some embodiments, the parallel coupled line coupler may be implemented on an integrated circuit (IC). In some aspects, the lines may be referred to as traces (e.g., on an IC). The lines and the attachment elements may be formed of copper and/or other IC metal (e.g., dependent on the IC manufacturing process). In some aspects, when the IC is sitting on a package, the transmission lines that form the parallel coupled line coupler may obtain characteristics of a microstrip line (e.g., the main transmission line and the coupled transmission lines may be considered edge coupled lines). In one aspect, the IC may include a parallel coupled line coupler, bumps associated with the ports of the parallel coupled line coupler, and conductive routing (if needed) from the parallel coupled line coupler to the bumps. In some cases, when designing an IC, bumps and switches (if applicable) may be placed on an IC layout and then the parallel coupled line coupler designed with an appropriate shape and size, along with appropriate routing if needed, to couple the parallel coupled line coupler to the bumps and the switches (if applicable).

Using various embodiments, parallel coupled line couplers having two parallel lines coupled to a main signal path of a main line may allow for size reduction (e.g., shorter length and/or less area) and routing flexibility (e.g., coupling the lines with bumps and/or switches) while achieving similar coupling characteristics (e.g., a desired coupling factor and directivity to meet specification), relative to conventional coupler structures in which a single line is coupled to a main line. The parallel coupled line couplers may be designed with appropriate performance characteristics (e.g., coupling factor, directivity, etc.), shape, size, manufacturing process (e.g., material, complexity, etc.), and so forth to operate in any desired frequency band. In some cases, the single line of conventional coupler structures may need to turn multiple times around the main line, thus encompassing larger area, to achieve desired coupling characteristics. Size reduction and/or routing flexibility according to various embodiments of the parallel coupled line couplers may be even more evident at lower frequencies, which are generally associated with longer required coupling lengths and associated higher area consumption (e.g., area on chip when a coupler is implemented in an IC) than higher frequencies. In some embodiments, the parallel coupled line couplers may operate at radio frequencies (RF). In some embodiments, the parallel coupled line couplers may operate at a frequency below 6 GHz. An example operating frequency range of a parallel coupled line coupler may be between 0.5 GHz and 5 GHz. The parallel coupled line couplers may be operated in other frequency ranges with appropriate adjustments to, for example, their dimensions and/or shape to meet desired coupling characteristics.

It is noted that structures and/or portions thereof in the present disclosure may be described using terms such as equidistant, parallel, perpendicular, and so forth. Due to tolerances associated with dimensional aspects and/or fabrication processes/flows, such terms generally describe the structures and/or portions thereof in a nominal/substantial sense. As one example, coupled lines described and depicted as being parallel to a main line may correspond to coupled lines nominally/substantially parallel to the main line.

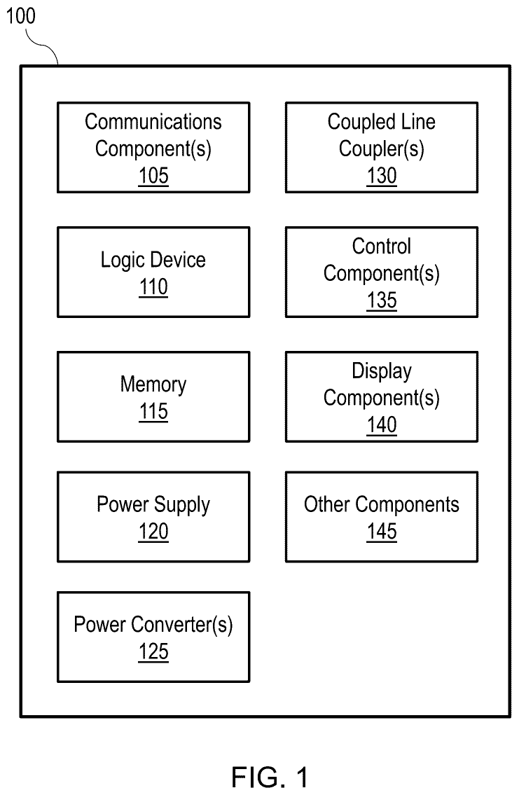

FIG. 1 illustrates an example system 100 in which a parallel coupled line coupler may be implemented in accordance with one or more embodiments of the present disclosure. Not all of the depicted components may be required, however, and one or more embodiments may include additional components not shown in the figure. Variations in the arrangement and type of the components may be made without departing from the spirit or scope of the claims as set forth herein. Additional, fewer, and/or different components may be provided.

The system 100 may be, may include, or may be a part of, a mobile phone, a computer, a tablet device, a game console, a personal digital assistant, a wearable device, a video player and/or recorder, an audio player and/or recorder, and/or generally any system that may be operable to facilitate signal coupling. The system 100 includes a communications component 105, a logic device 110, a memory 115, a power supply 120, a power converter(s) 125, a coupled line coupler(s) 130, a control component 135, a display component 140, and other components 145. The communications component 105 may facilitate wireless and/or wired communication between components within the system 100 and/or between the system 100 and one or more other systems. In this regard, the communications component 105 may facilitate communication by the system 100 using one or more wireless communication technologies, such as Wi-Fi (IEEE 802.11ac, 802.11ad, etc.), cellular (3G, 4G, 5G, etc.), Bluetooth™, etc., and/or one or more wired communication technologies. In some cases, various components of the system 100, such as the logic device 110 and the memory 115, may be implemented using a single chip or multiple chips. The communications component 105 may facilitate wired and/or wireless inter-chip and/or intra-chip connections between these components.

The logic device 110 may be implemented as one or more of a general-purpose processor, a digital signal processor (DSP), an application-specific integrated circuit (ASIC), a microcontroller, a programmable logic device (PLD) (e.g., a field-programmable gate array (FPGA)), or other logic device. The logic device 110 may be configured through hardwiring, software execution, or a combination of both to facilitate operation of the system 100. In this regard, the logic device 110 may be configured to interface and communicate with the various other components (e.g., 105, 115, 120, 125, 130, 135, 140, and/or 145) of the system 100 to perform such operation. In some embodiments, the logic device 110 may communicate with the coupled line coupler(s) 130 to facilitate generation of a desired output signal(s) (e.g., desired power at an output port and a coupled port) by the coupled line coupler(s) 130. In some aspects, at least one of the coupled line coupler(s) 130 may have a selectable coupler size. The logic device 110 may provide control signals to the coupled line coupler(s) 130 (e.g., to set a state of switches of the coupled line coupler(s) 130) to select the desired coupler size.

The memory 115 may include one or more memory devices designed to retain data, such as software instructions for execution by the logic device 110. The memory 115 may include volatile memories and/or non-volatile memories, such as random-access memory (RAM), dynamic RAM (DRAM), static RAM (SRAM), non-volatile random-access memory (NVRAM), read-only memory (ROM), programmable read-only memory (PROM), erasable programmable read-only memory (EPROM), electrically-erasable programmable read-only memory (EEPROM), flash memory, hard disk drives, and/or other memory types. As discussed above, the logic device 110 may be configured to execute software instructions stored in the memory 115 so as to perform method and process steps and/or operations.

The power supply 120 may supply power to operate the system 100, such as by supplying power to the various components of the system 100. The power supply 120 may be, or may include, one or more batteries (e.g., rechargeable batteries, non-rechargeable batteries). The batteries may be a lithium ion battery, lithium polymer battery, nickel cadmium battery, nickel metal hydride battery, or any other battery suitable to supply power to operate the system 100. Alternatively or in addition, the power supply 120 may be, or may include, one or more solar cells. The solar cells may be utilized to supply power to operate the system 100 and/or to charge one or more rechargeable batteries. The power converter(s) 125 may receive power from the power supply 120 and generate appropriate power to various components of the system 100 (e.g., based on the power received from the power supply 120).

The coupled line coupler(s) 130 may have an input port, an output port, a coupled port, and an isolated port. The coupled line coupler(s) 130 may be used in any application in which transfer of a portion of a signal at the input port to each of the output port and the coupled port is desired. At least one of the coupled line coupler(s) 130 may include a parallel coupled line coupler in accordance with one or more embodiments. As further described herein, the parallel coupled line coupler may include a main line coupled to the input port and the output port, coupled lines displaced from the main line, and additional lines for coupling the coupled lines together and to the coupled port and the isolated port. A portion of a signal propagating through the main line may couple into the coupled lines and to the coupled port and the isolated port via the additional lines. The isolated port is designed to be isolated and thus should receive negligible power (e.g., ideally/nominally zero power).

The control component 135 may include a user input and/or an interface device, such as a rotatable knob, push buttons, keyboard, and/or other devices, that is adapted to generate a user input control signal. The logic device 110 may be configured to receive control input signals from a user via the control component 135 and respond to any received control input signals.

The display component 140 may include an image display device (e.g., a liquid crystal display (LCD)) or various other types of generally known video displays or monitors. The logic device 110 may be configured to display data on the display component 140. In some aspects, the control component 135 may be implemented as part of the display component 140. For example, a touchscreen of the system 100 may provide both the control component 135 (e.g., for receiving user input via gestures) and the display component 140.

The other components 145 may be used to implement any features of the system 100 as may be desired for various applications. In some aspects, the other components 145 may include, by way of non-limiting examples, clock generators, counters, timers, and sensors. A sensor may respond to a stimulus (e.g., heat, light, sound pressure, etc.), such as generating a signal(s) in response to the stimulus. Non-limiting examples of a sensor may include an accelerometer, a gyroscope, a thermometer, a light sensor, a barometer, a proximity sensor, a camera, a microphone, and/or any combination thereof.

In some embodiments, various components of the system 100 may be combined and/or implemented or not depending on application. In one example, the logic device 110 may be combined with the memory 115, the power supply 120, the power converter(s) 125, the coupled line coupler(s) 130, the control component 135, and/or a sensor(s) of the other components 145. In another example, the logic device 110 may be combined with the coupled line coupler(s) 130, such that certain functions of the logic device 110 are performed by circuitry (e.g., a processor, a microprocessor, a logic device, a microcontroller, etc.) within the coupled line coupler(s) 130. In yet another example, the system 100 does not include the control component 135 and/or the display component 140.

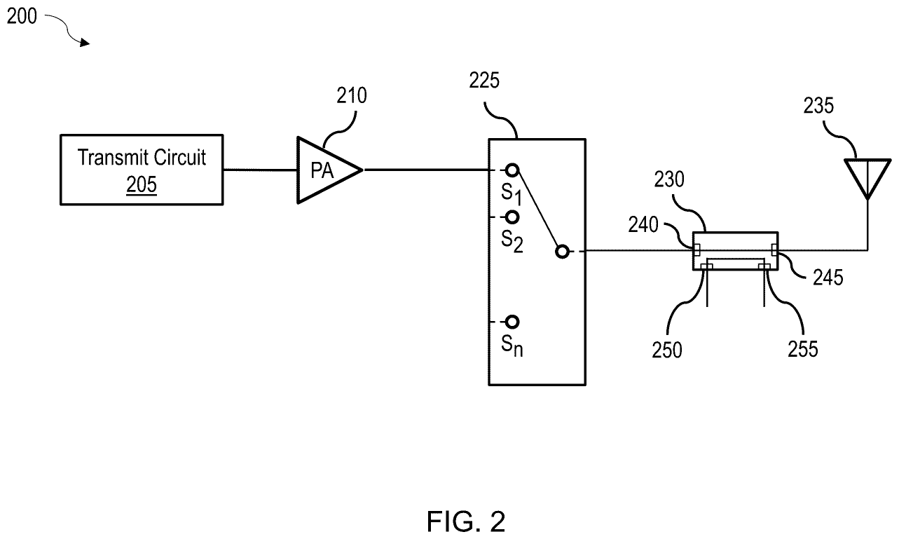

FIG. 2 illustrates an example transmitter system 200 with a parallel coupled line coupler 230 in accordance with one or more embodiments of the present disclosure. Not all of the depicted components may be required, however, and one or more embodiments may include additional components not shown in the figure. Variations in the arrangement and type of the components may be made without departing from the spirit or scope of the claims as set forth herein. Additional, fewer, and/or different components may be provided.

The transmitter system 200 includes a transmit circuit 205, a power amplifier 210, an antenna switch circuit 225, the coupled line coupler 230, and an antenna 235. The transmit circuit 205 and the power amplifier 210 may form a transmit path. The transmit circuit 205 may generate a signal (e.g., a radio frequency signal). The power amplifier 210 may receive the signal from the transmit circuit 205 and amplify the received signal. The antenna switch circuit 225 may selectively couple the transmit path formed of the transmit circuit 205 and the power amplifier 215 or other transmit path (not shown) to the coupled line coupler 230. In some cases, when the transmitter system 200 needs to accommodate only a single transmit path, the antenna circuit 225 may be removed from the transmitter system 200.

The coupled line coupler 230 includes an input port 240, an output port 245, a coupled port 250, and an isolated port 255. When the power amplifier 210 is connected to the coupled line coupler 230 via the antenna switch circuit 225 (or directly connected to the coupled line coupler 230 when the antenna switch circuit 225 is omitted), the signal from the power amplifier 210 is provided to the input port 240 of the coupled line coupler 230. A respective portion of the signal received at the input port 240 is provided to the output port 245 and to the coupled port 250.

FIG. 3 illustrates a view of an example parallel coupled line coupler 300 in accordance with one or more embodiments of the present disclosure. The parallel coupled line coupler 300 extends along three directions (e.g., three orthogonal directions) x, y, and z, as shown by the coordinate system in FIG. 3. In some embodiments, the parallel coupled line coupler 300 may be implemented on an IC. In such embodiments, FIG. 3 may illustrate a top view of a layout of the parallel coupled line coupler 300. Not all of the depicted components may be required, however, and one or more embodiments may include additional components not shown in the figure. Variations in the arrangement and type of the components may be made without departing from the spirit or scope of the claims as set forth herein. Additional, fewer, and/or different components may be provided.

The parallel coupled line coupler 300 has an input port, an output port (e.g., also referred to as a through port), a coupled port (e.g., also referred to as a coupled forward port or a forward port), and an isolated port (e.g., also referred to as a coupled reverse port or reverse port). The parallel coupled line coupler 300 includes a main transmission line 305, coupled transmission lines 310 and 315, and transmission lines 320 and 325. In an aspect, the transmission lines 320 and 325 do not physically contact the main transmission line 305. The main transmission line 305 has a first end coupled to the input port and a second end coupled to the output port. The transmission line 320 is coupled to a first end of both the coupled transmission lines 310 and 315 and coupled to the coupled port. The transmission line 325 is coupled to a second end of both the coupled transmission lines 310 and 315 and coupled to the isolated port. In this regard, the transmission line 320 couples together the first end of the coupled transmission lines 310 and 315, and the transmission line 325 couples together the second end of the coupled transmission lines 310 and 315.

In an aspect, the transmission line 320 and the first end of the coupled transmission lines 310 and 315 may be, or may be considered as, effectively forming an end of a single coupled transmission line of the main transmission line 305 that is coupled to the coupled port. Similarly, the transmission line 325 and the second end of the coupled transmission lines 310 and 315 may be, or may be considered as, effectively forming an end of a single coupled transmission line of the main transmission line 305 that is coupled to the isolated port. It is noted that a signal propagating in the main transmission line 305 may couple directly to the transmission lines 320 and 325. In general, there is no concern (e.g., in terms of desired performance/coupler characteristics) of signal coupling between the transmission lines 320 and 325 and the main transmission line 305 since the transmission lines 320 and 325 are meant to connect the coupled transmission lines 310 and 315 which are already coupling to the main transmission line 305.

As shown in the view (e.g., top view) of FIG. 3, the coupled lines 310 and 315 are parallel to at least a portion of the main line 305. As such, the coupled lines 310 and 315 may be referred to as parallel coupled lines of the main line 305. The coupled line 310 is displaced from the main line 305 by a distance d₁ along a first direction (e.g., +z direction). The coupled transmission line 315 is displaced from the main line 305 by a distance d₂ along a second direction (e.g., −z direction) opposite the first direction. In some cases, the main line 305 is nominally/substantially equidistant along the z-direction from the coupled transmission lines 310 and 315.

At least a portion of the lines 320 and 325 may be perpendicular to the coupled lines 310 and 315. In some aspects, since the line 320 and 325 cross the coupled lines 310 and 315 and the main line 305, the lines 320 and 325 may be referred to as crossing transmission lines or crossing lines. In some aspects, the ends of each of the coupled lines 310 and 315 may be coupled to the transmission lines 320 and 325 via respective attachment elements. These attachment elements may have a thickness that displaces the transmission lines 320 and 325 along the +y-direction from the main line 305, such that the transmission lines 320 and 325 do not contact the main line 305. The main line 305, the coupled lines 310 and 315, and the lines 320 and 325 are formed of conductive material and may be referred to as conductive transmission lines or simply conductive lines. The conductive material may be selected from materials associated with a given manufacturing process. As an example, the lines 305, 310, 315, 320, and 325 may be formed of metal, such as copper. In some cases, the attachment elements may also be formed of conductive material, such as copper.

It is noted that structures and/or portions thereof in the present disclosure may be described using terms such as equidistant, parallel, perpendicular, and so forth. Due to tolerances associated with dimensional aspects and/or fabrication processes/flows, such terms generally describe the structures and/or portions thereof in a nominal/substantial sense. As one example, coupled lines (e.g., the coupled lines 310 and 315) described and depicted as being parallel to a main line (e.g., the main line 305) and parallel to the x-direction may correspond to coupled lines nominally/substantially parallel to the main line and nominally/substantially parallel to the x-direction.

The parallel coupled line coupler 300 may be characterized using performance/coupler characteristics such as a coupling factor (CF or C), a directivity (D), an isolation (I), an insertion loss (IL), and a return loss (RL), as would be understood by one skilled in the art. Other characteristics associated with the parallel coupled line coupler 300 may include a size and a manufacturing complexity/cost associated with the parallel coupled line coupler 300. For example, a tradeoff may be present between a size and/or a manufacturing complexity/cost and one or more of the performance characteristics. In general, characteristics associated with the parallel coupled line coupler 300 are frequency dependent.

Various performance characteristics generally relate a power associated with one port of the parallel coupled line coupler 300 with another port of the parallel coupled line coupler 300. An input power is provided to the input port of the parallel coupled line coupler 300. The output port receives a portion of the input power provided to the input port. The coupled port receives a portion of the input power provided to the input port. The isolated port is isolated from the input port. As examples, the coupling factor may be based on a ratio of the input power provided to the input port and a power received at the coupled port (e.g., indicative of a portion of the input power that is coupled to the coupled port), the directivity may be based on a ratio of the power received at the coupled port and a power received at the isolated port, and the isolation may be based on a ratio of the input power provided to the input port and a power received at the isolation port.

It is noted that various dimensions and spacings of the parallel coupled line coupler 300 may be designed/determined based on desired characteristics over a desired frequency range. In this regard, spacings and dimensions such as, by way of non-limiting examples, the spacing d₁ between the main line 305 and the coupled line 310, the spacing d₂ between the main line 305 and the coupled line 315, a width wₘ of the main line 305, a width w₁ of the coupled line 310, a width w₂ of the coupled line 315, a width w_{c} of the line 320, a width w₁ of the line 325, and/or a coupled length L (e.g., also referred to as a length) of the parallel coupled line coupler 300 may be tuned as appropriate to achieve the desired characteristics over the desired frequency range. The coupled length L may be a length of the main line 305 or portion thereof that is coupled to the coupled lines 310 and 315. As shown in FIG. 3, the length L may extend from a leftmost side of the line 325 to a rightmost side of the line 320. An example spacing d₁ and d₂ may be between approximately 2.0 μm and approximately 3.0 μm. An example width wₘ of the main line 305 may be between approximately 6.0 μm and approximately 7.5 μm. An example width w₁ and w₂ of the coupled lines 310 and 315, respectively, may be between approximately 2.5 μm and approximately 3.5 μm. In some cases, the widths w₁ and w₂ may be nominally/substantially the same. An example width w_{c} and width wᵢ of the lines 320 and 325, respectively, may be between approximately 3.5 μm and 4.5 μm. In some cases, the widths w_{c} and w₁ may be nominally/substantially the same. An example length L of the parallel coupled line coupler 300 may be between approximately 200 μm to approximately 300 μm.

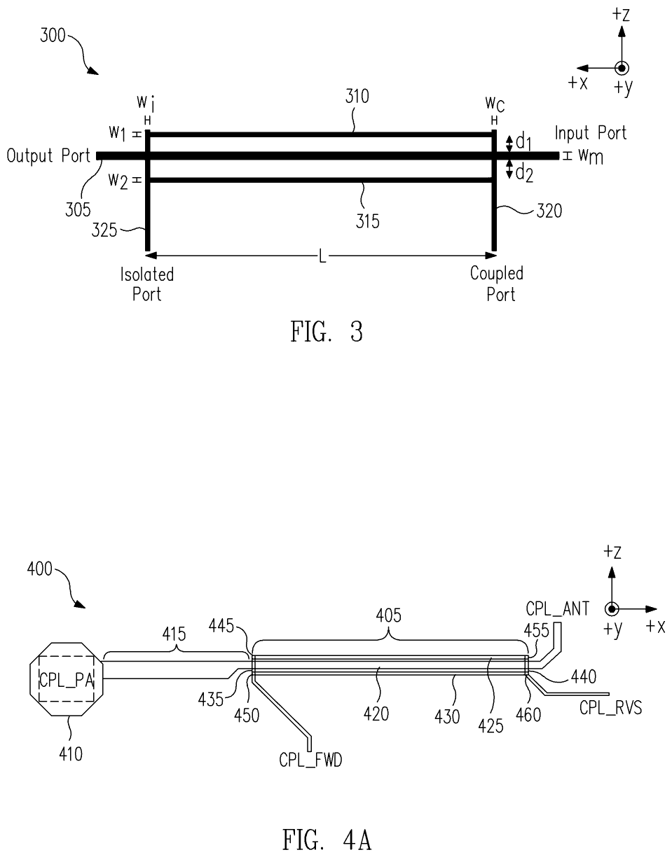

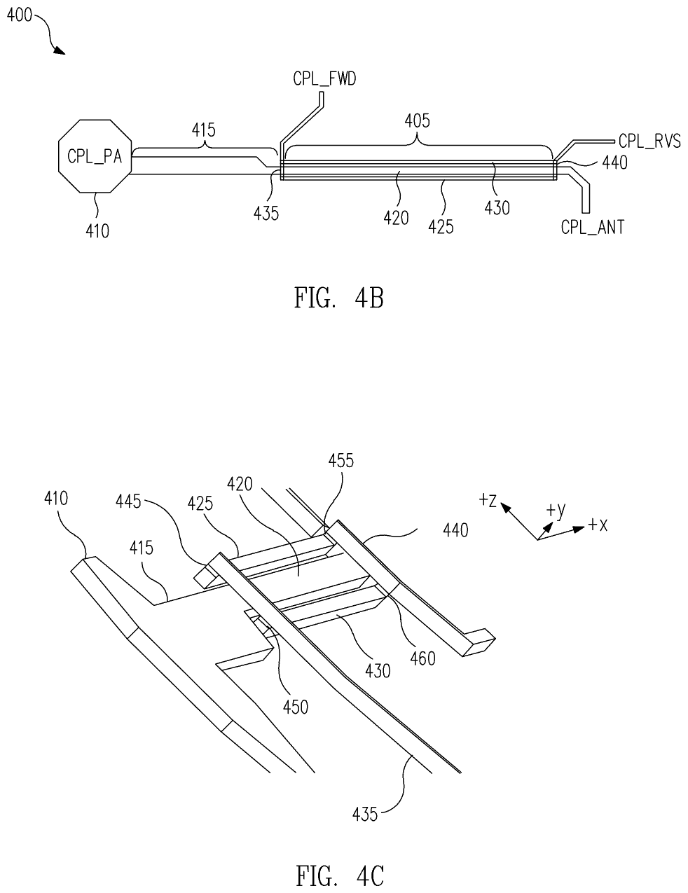

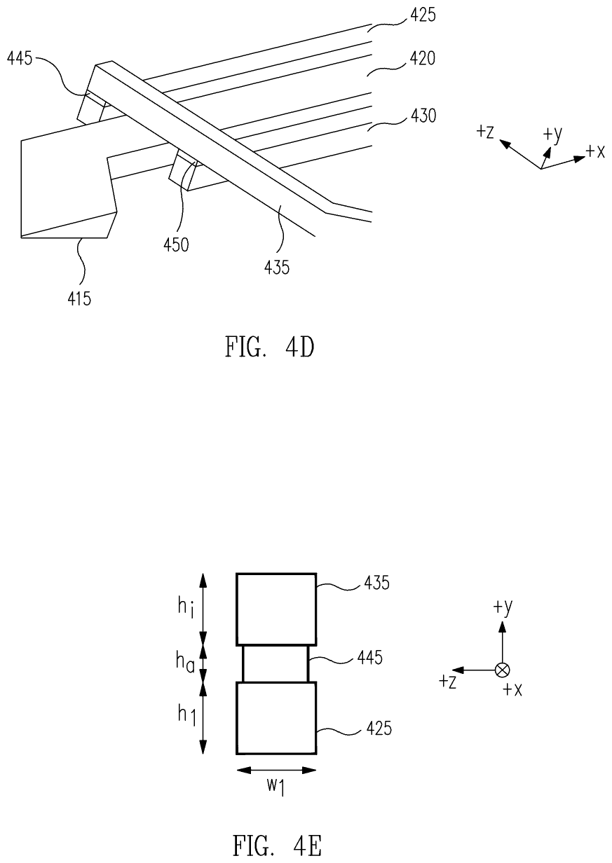

FIG. 4A illustrates a view (e.g., top view) of an example transmitter circuit 400 having a parallel coupled line coupler 405 in accordance with one or more embodiments of the present disclosure. FIG. 4B illustrates a perspective view of the transmitter circuit 400 in accordance with one or more embodiments of the present disclosure. FIGS. 4C and 4D illustrate perspective views of the transmitter circuit 400 that are zoomed-in relative to the perspective view of FIG. 4B in accordance with one or more embodiments of the present disclosure. In some embodiments, the parallel coupled line coupler 405 may be, may include, may be a part of, and/or may correspond to the parallel coupled line coupler 300 of FIG. 3 and, as such, the description of the parallel coupled line coupler 300 of FIG. 3, including the example spacings and dimensions, generally apply to the parallel coupled line coupler 405. Not all of the depicted components may be required, however, and one or more embodiments may include additional components not shown in the figures. Variations in the arrangement and type of the components may be made without departing from the spirit or scope of the claims as set forth herein. Additional, fewer, and/or different components may be provided.

The transmitter circuit 400 may be implemented on an IC. The parallel coupled line coupler 405 has an input port, an output port, a coupled port, and an isolated port. The transmitter circuit 400 has a bump 410 for providing power from a power amplifier to the input port of the parallel coupled line coupler 405. In this regard, the power propagates from the bump 410 through an extension 415 (e.g., coupled between the bump 410 and the input port of the parallel coupled line coupler 405) and to the parallel coupled line coupler 405. The extension 415 may be omitted when the main line 420 may be directly coupled to the bump 410. In this regard, the extension 415 may represent any routing (e.g., conductive routing) between the bump 410 and the main line 420. A respective portion of the power received at the input port may be provided to the output port and the coupled port of the parallel coupled line coupler 405. The isolated port is designed to be isolated (e.g., according to desired performance characteristics) and thus should receive negligible power (e.g., ideally/nominally zero power). The input port of the parallel coupled line coupler 405 may effectively be extended by the extension 415 to the bump 410. In this regard, the input port of the parallel coupled line coupler 405 is coupled to, and/or may be considered as being provided by the bump 410, and thus the input port may be denoted as CPL_PA. The output port may be coupled to an antenna and thus denoted as CPL_ANT. The coupled port may be referred to as a coupled forward port and thus denoted as CPL_FWD. The isolated port may be referred to as a coupled reverse port and thus denoted as CPL_RVS.

The parallel coupled line coupler 405 includes a main line 420, coupled lines 425 and 430, and lines 435 and 440. The main line 420 is coupled to the input port and the output port. The line 435 is coupled to a first end of the coupled lines 425 and 430 and to the coupled port. The line 440 is coupled to a second end of the coupled lines 425 and 430 and to the isolated port. In this regard, the lines 435 and 440 connect the coupled lines 425 and 430 to the coupled port and the isolated port, respectively. As shown and labeled in FIGS. 4A, 4C, and 4D, the line 435 may be coupled to the first end of the coupled lines 425 and 430 by attachment elements 445 and 450 (e.g., also referred to as connector elements, connectors, or vias), respectively, and the line 440 may be coupled to the second end of the coupled lines 425 and 430 by attachment elements 455 and 460, respectively. The main line 420, the coupled lines 425 and 430, the lines 435 and 440, and the attachment elements 445, 450, 455, and 460 may be formed of conductive material. As an example, the lines 420, 425, 430, 435, and 440 and the attachment elements 445, 450, 455, and 460 may be formed of metal, such as copper.

FIG. 4E illustrates a cross-sectional view (e.g., y-z plane) of the attachment element 445 coupling the coupled line 425 to the line 435. An example width w₁ of the coupled line 425 may be between approximately 2.5 μm and approximately 3.5 μm. An example thickness/height h₁ and hᵢ of the coupled line 425 and the line 435, respectively, may be between approximately 3.0 μm and approximately 4.0 μm. An example thickness/height of the attachment element 445 may be between approximately 0.5 μm and approximately 1.0 μm. The attachment elements 450, 455, and 460 for coupling the coupled line 425 or 430 to the line 435 or 440 may be associated with similar cross-sectional views and/or similar dimensions. It is noted that a height/thickness of the main line 420 may be the same or may be different from a height/thickness of the coupled lines 425 and/or 430.

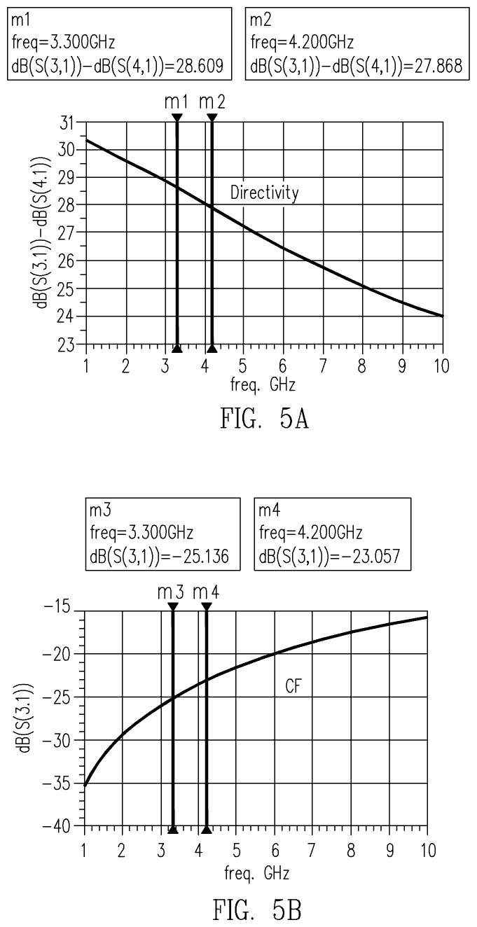

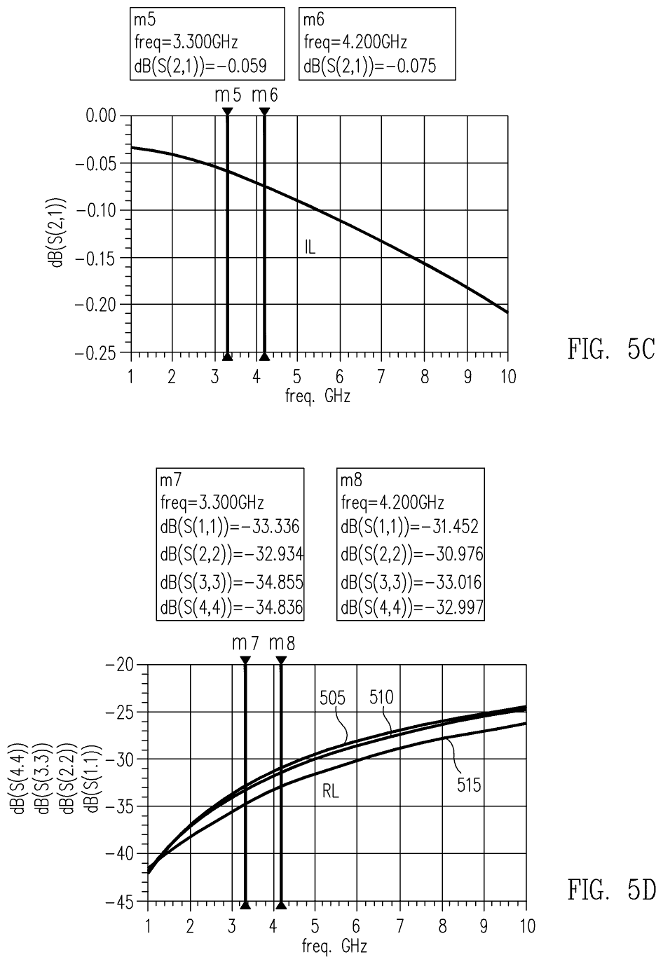

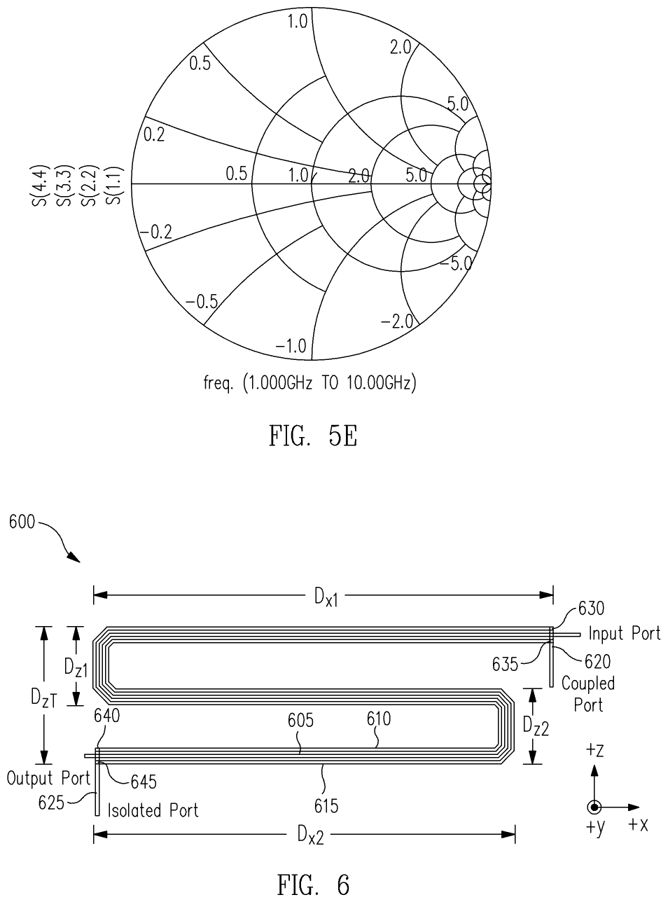

FIGS. 5A through 5E illustrate example performance/coupler characteristics associated with the parallel coupled line coupler 405 of the transmitter circuit 400 of FIG. 4A in accordance with one or more embodiments of the present disclosure. In each of FIGS. 5A through 5D, markers identify values of the corresponding coupler characteristics at frequencies of 3.3 GHZ and 4.2 GHz. FIG. 5A illustrates a directivity (provided by a difference S₃₁−S₄₁ between the S-parameters S₃₁ and S₄₁) as a function of frequency for the parallel coupled line coupler 405. FIG. 5B illustrates a coupling factor (provided by the S-parameter S₃₁) as a function of frequency for the parallel coupled line coupler 405. FIG. 5C illustrates an insertion loss (provided by the S-parameter S₂₁) as a function of frequency for the parallel coupled line coupler 405. FIG. 5D illustrates a return loss (provided by the S-parameters S₁₁, S₂₂, S₃₃, and S₄₄) as a function of frequency for the parallel coupled line coupler 405. A curve 505 provides the S-parameter S₂₂ as a function of frequency. A curve 510 provides the S-parameter S₁₁ as a function of frequency. A curve 515 provides the S-parameters S₃₃ and S₄₄ as a function of frequency. In this regard, curves associated with the S-parameters S₃₃ and S₄₄ substantially overlap. FIG. 5E illustrates a Smith chart associated with the parallel coupled line coupler 405.

Although the foregoing provides examples of parallel coupled line couplers that extend along a length that runs along a single direction (e.g., along the x-direction), in some embodiments, parallel coupled line couplers may generally be of any shape to utilize available space (e.g., on a chip) while achieving desired performance characteristics. When a parallel coupled line coupler is implemented on a chip, a layout of a parallel coupled line coupler may be designed based on bump placements and, in some cases, switch placement (e.g., for facilitating multiband operation and/or otherwise providing switchable coupler size). In this regard, a position of bumps and, in some cases, switches, may provide constraints on a size and/or a shape of a parallel coupled line coupler. As such, when designing a parallel coupled line coupler, the parallel coupled line coupler may be reshaped and/or resized as appropriate/possible based on bump placement, switch placement, and desired performance characteristics.

FIG. 6 illustrates a view (e.g., a top view of a layout) of an example parallel coupled line coupler 600 in accordance with one or more embodiments of the present disclosure. The parallel coupled line coupler 600 extends along three directions (e.g., three orthogonal directions) x, y, and z, as shown by the coordinate system in FIG. 6. Not all of the depicted components may be required, however, and one or more embodiments may include additional components not shown in the figure. Variations in the arrangement and type of the components may be made without departing from the spirit or scope of the claims as set forth herein. Additional, fewer, and/or different components may be provided. The description of the parallel coupled line coupler 300 and 405 of FIGS. 3 and 4A generally apply to the parallel coupled line coupler 600, with examples of differences and other description provided herein.

The parallel coupled line coupler 600 includes a main line 605, coupled lines 610 and 615, and lines 620 and 625. As shown in FIG. 6, the parallel coupled line coupler 600 has a serpentine shape (e.g., also referred to as an s-shape or z-shape). In this regard, each of the main line 605 and the coupled lines 610 and 615 has a serpentine shape in the xz-plane, with the coupled lines 610 and 615 remaining parallel to the main line 605 and displaced from the main line 605 by a substantially constant distance/spacing (denoted as d₁ and d₂, respectively, in FIG. 3) as a length of the main line 605 and the coupled lines 610 and 615 extend along the serpentine shape in the xz-plane.

The main line 605 is coupled to an input port and an output port of the parallel coupled line coupler 600. The line 620 is coupled to a first end of the coupled lines 610 and 615 via attachment elements 630 and 635, respectively, and coupled to a coupled port of the parallel coupled line coupler 600. The line 625 is coupled to a second end of the coupled lines 610 and 615 via attachment elements 640 and 645, respectively, and coupled to an isolated port of the parallel coupled line coupler 600. In this regard, the lines 620 and 625 connect the coupled lines 610 and 615 together and to the coupled port and the isolated port, respectively. The main line 605, the coupled lines 610 and 615, and the lines 620 and 625, and the attachment elements 630, 635, 640, and 645 may be formed of conductive material. As an example, the lines 605, 610, 615, 620, and 625 and the attachment elements 630, 635, 640, and 645 may be formed of metal, such as copper. In some cases, the serpentine shape may allow for a reduced coupler area and allow reduction or avoidance of extra routing losses between the parallel coupled line coupler 600 and an antenna switch (e.g., the antenna switch circuit 225) and/or an antenna (e.g., the antenna 235).

In some embodiments, the parallel coupled line coupler 600 may be utilized for low frequency band (e.g., also referred to as low band) operation. As one example, the frequency band may encompass frequencies from around 600 MHz to around 1,000 MHz. An example extent/dimension Dₓ₁ of the parallel coupled line coupler 600 along the x-direction may be between approximately 350 μm and approximately 450 μm. An example extent/dimension Dₓ₂ of the parallel coupled line coupler 600 along the x-direction may be between approximately 300 μm and approximately 400 μm. An example extent/dimension D_{z1} and D_{z2} of the parallel coupled line coupler 600 along the z-direction may each be between approximately 50 μm and approximately 100 μm. An example extent/dimension D_{zT} of the parallel coupled line coupler 600 along the z-direction may be between approximately 100 μm and approximately 200 μm. An example spacing between the main line 605 and the coupled lines 610 and 615 (denoted as d₁ and d₂, respectively, in FIG. 3) may be between approximately 2.0 μm and approximately 4.0 μm. An example width of the main line 605 and the coupled lines 610 and 615 (denoted as wₘ, w₁, and w₂, respectively, in FIG. 3) may be between approximately 2.0 μm and approximately 4.0 μm.

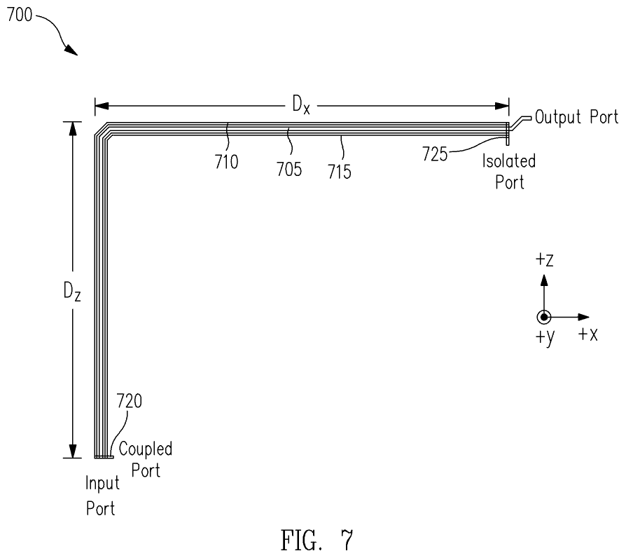

FIG. 7 illustrates a view (e.g., a top view of a layout) of another example parallel coupled line coupler 700 in accordance with one or more embodiments of the present disclosure. The parallel coupled line coupler 700 extends along three directions (e.g., three orthogonal directions) x, y, and z, as shown by the coordinate system in FIG. 7. Not all of the depicted components may be required, however, and one or more embodiments may include additional components not shown in the figure. Variations in the arrangement and type of the components may be made without departing from the spirit or scope of the claims as set forth herein. Additional, fewer, and/or different components may be provided. The description of the parallel coupled line coupler 300, 405, and 600 of FIGS. 3, 4A, and 6 generally apply to the parallel coupled line coupler 700, with examples of differences and other description provided herein.

The parallel coupled line coupler 700 includes a main line 705, coupled lines 710 and 715, and lines 720 and 725. As shown in FIG. 7, the parallel coupled line coupler 700 has an L-shape in the xz-plane. In this regard, each of the main line 705 and the coupled lines 710 and 715 has an L-shape, with the coupled lines 710 and 715 remaining parallel to the main line 705 and displaced from the main line 705 by a substantially constant distance/spacing (denoted as d₁ and d₂, respectively, in FIG. 3) as a length of the main line 705 and the coupled lines 710 and 715 extend along the L-shape. The main line 705 is coupled to an input port and an output port of the parallel coupled line coupler 700. The line 720 is coupled to a first end of the coupled lines 710 and 715 via attachment elements and coupled to a coupled port of the parallel coupled line coupler 700. The line 725 is coupled to a second end of the coupled lines 710 and 715 via attachment elements and coupled to an isolated port of the parallel coupled line coupler 700. In this regard, the lines 720 and 725 connect the coupled lines 710 and 715 together and to the coupled port and the isolated port, respectively. The main line 705, the coupled lines 710 and 715, the lines 720 and 725, and the attachment elements may be formed of conductive material (e.g., metal such as copper). In some cases, the L-shape may allow for a large reduction in coupler area while maintaining desired insertion loss and directivity characteristics. In some cases, an IC floorplan and bump placement may be adjusted to allow for the L-shape or the L-shape may be reshaped as appropriate with respect to bump position.

In some embodiments, the parallel coupled line coupler 700 may be utilized for low frequency band (e.g., also referred to as low band) operation. An example extent/dimension Dx of the parallel coupled line coupler 700 along the x-direction may be between approximately 500 μm and approximately 600 μm. An example extent/dimension D_{z} of the parallel coupled line coupler 700 along the z-direction may be between approximately 400 μm and approximately 500 μm. An example spacing between the main line 705 and the coupled lines 710 and 715 (denoted as d₁ and d₂, respectively, in FIG. 3) may be between approximately 1.5 μm and approximately 2.5 μm. An example width of the main line 705 (denoted as wₘ in FIG. 3) may be between approximately 3.5 μm and approximately 6.5 μm. An example width of the coupled lines 710 and 715 (denoted as w₁ and w₂, respectively, in FIG. 3) may be between approximately 2.0 μm and approximately 4.0 μm. For a given set of coupling characteristics, this L-shape may be associated with a size reduction relative to conventional design in which a single coupled line may turn multiple times around a main line and thus encompass more area. Furthermore, the parallel coupled line coupler 700 may continue to be iteratively reshaped, such as into a more serpentine shape like the parallel coupled line coupler 600 and/or other shape, during a design process as appropriate to achieve desired coupling characteristics.

It is noted that the parallel coupled line couplers of FIGS. 6 and 7 may have a cross-sectional view of an attachment element (e.g., the attachment element 630) coupling a coupled line (e.g., the coupled line 610 or 710) to a line (e.g., the line 620 or 720) similar to and/or corresponding to the cross-sectional view illustrated in FIG. 4E. In this regard, with reference to the parallel coupled line couplers of FIGS. 6 and 7, an example thickness/height h₁ and hᵢ of the coupled line 610/710 and the line 620/720, respectively, may be between approximately 2.5 μm and approximately 4.0 μm. An example thickness/height of the attachment element 630 may be between approximately 1.0 μm and approximately 1.5 μm. Other attachments and lines may be associated with similar cross-sectional views and/or similar dimensions. A height/thickness of the main line 605 or 705 may be the same or may be different from a height/thickness of the coupled lines.

In some embodiments, parallel coupled line couplers may have a selectable size (e.g., selectable length, selectable area). In an aspect, the selectable size may also be referred to as a configurable size or a switchable size. The size of such parallel coupled line couplers may be selected to allow operation in a desired frequency band. In some aspects, accommodation of multiple frequency bands by a single parallel coupled line coupler having a selectable size is generally associated with savings (e.g., chip real estate savings) relative to a case in which multiple couplers are used to handle the different frequency bands. In some aspects, such parallel coupled line couplers may include multiple sections and may be referred to as multi-section parallel coupled line couplers. Each section includes a main transmission line, coupled transmission line in parallel with the main transmission line, and crossing transmission lines that connect the coupled transmission lines to the coupled port and the isolated port. Each section may be selectively coupled (e.g., using one or more switches that can be closed/on or open/off) to one or more other sections. A state (e.g., closed/on or open/off state) of each switch may be based on a control signal applied to the switch. In an aspect, control signals for the switches may be provided by a logic device (e.g., the logic device 110 of FIG. 1). In some cases, a switch may be implemented using a transistor, with a control signal (e.g., driven to an appropriate voltage level) provided to a gate of the transistor.

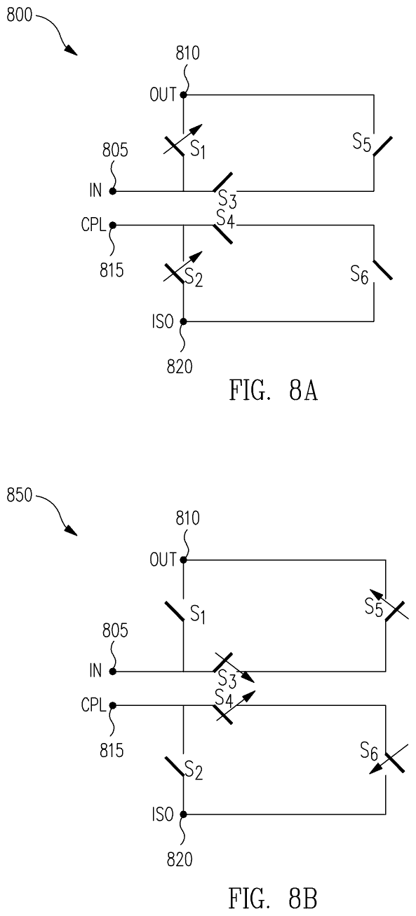

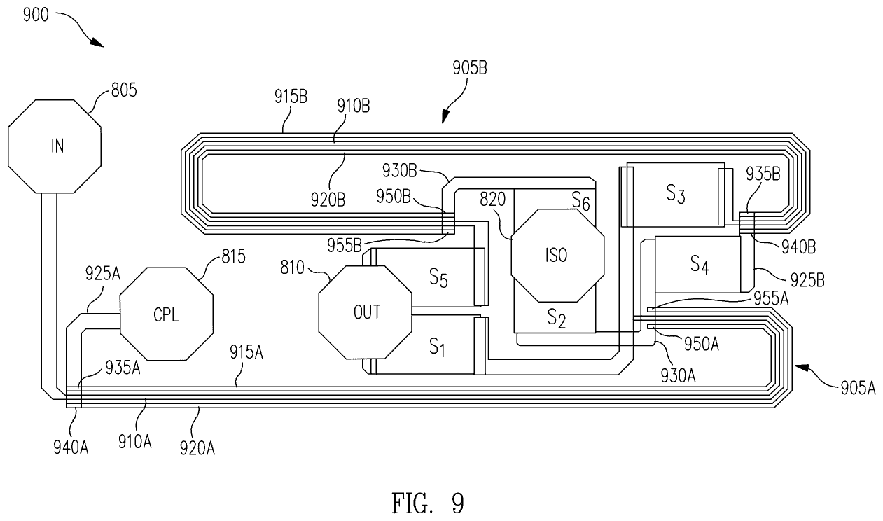

FIGS. 8A and 8B illustrate a first configuration 800 and a second configuration 850, respectively, of a parallel coupled line coupler in accordance with one or more embodiments of the present disclosure. FIG. 9 illustrates an example layout 900 for implementing the parallel coupled line coupler of FIGS. 8A and 8B in accordance with one or more embodiments of the present disclosure. Not all of the depicted components may be required, however, and one or more embodiments may include additional components not shown in the figures. Variations in the arrangement and type of the components may be made without departing from the spirit or scope of the claims as set forth herein. Additional, fewer, and/or different components may be provided.

Although for explanatory purposes the first configuration 800 and the second configuration 850 of FIGS. 8A and 8B, respectively, are described with reference to the layout 900 of the parallel coupled line coupler, other layouts may be used to implement the parallel coupled line coupler of FIGS. 8A and 8B. In this regard, an IC layout may include a parallel coupled line coupler, bumps, and/or switches having different shapes and/or sizes and/or differently positioned/arranged from that illustrated in the layout 900.

The first configuration 800 may be associated with operation in a first frequency band and the second configuration 850 may be associated with operation in a second frequency band. The first frequency band (e.g., referred to as mid band) may generally be associated with higher frequencies than the second frequency band (e.g., referred to as low band). The first frequency band and the second frequency band may or may not overlap. As such, the parallel coupled line coupler may have the first configuration 800 during mid band operation and the second configuration 850 during low band operation. In this regard, the parallel coupled line coupler may be configured to operate as a mid band coupler when in the first configuration 800 and a low band coupler when in the second configuration 850. Since the parallel coupled line coupler allows operation in two frequency bands, the parallel coupled line coupler may be referred to as a dual band parallel coupled line coupler. As non-limiting examples, the first frequency band may encompass frequencies from around 1,600 MHz to around 2,100 MHz, and/or the second frequency band may encompass frequencies from around 600 MHz to around 1,000 MHz.

The layout 900 includes the parallel coupled line coupler, bumps 805, 810, 815, and 820, and switches S₁ through S₆. The switches S₁ through S₆ may form a switch circuit associated with operation of the parallel coupled line coupler. The parallel coupled line coupler has an input (IN) port (e.g., a power amplifier (PA) port for receiving power from a power amplifier), an output (OUT) port (e.g., an antenna (ANT) port), a coupled (CPL) port, and an isolated (ISO) port. As shown in FIGS. 8A, 8B, and 9, the input port, the output port, coupled port, and the isolated port of the parallel coupled line coupler are coupled to the bumps 805, 810, 815, and 820, respectively. In this regard, in an aspect, the input port, the output port, the coupled port, and the isolated port may be considered to be, and may be referred to interchangeably with, the bumps 805, 810, 815, and 820, respectively.

As shown in the layout 900, the parallel coupled line coupler may include parallel coupled line coupler sections 905A and 905B. In general, the description of parallel coupled line couplers in association with various figures apply to each of the sections 905A and 905B. The section 905A includes a main transmission line 910A, coupled transmission lines 915A and 920A, transmission lines 925A and 930A, and attachment elements 935A, 945A, 950A, and 955A. The attachment elements 935A and 940A couple together a first end of the coupled lines 915A and 920A, respectively. The attachment elements 950A and 955A couple together a second end of the coupled lines 915A and 920A, respectively. A first end of the main line 910A is coupled to the bump 805. A second end of the main line 910A is coupled to the switches S₁ and S₃. The line 925A couples the first end of the coupled lines 915A and 920A to the bump 815. The line 930A couples the second end of the coupled lines 915A and 920A to the switches S₂ and S₄.

The section 905B includes a main transmission line 910B, coupled transmission lines 915B and 920B, transmission lines 925B and 930B, and attachment elements 935B, 945B, 950B, and 955B. The attachment elements 935B and 940B couple together a first end of the coupled lines 915B and 920B, respectively. The attachment elements 950B and 955B couple together a second end of the coupled lines 915B and 920B, respectively. A first end of the main line 910B is coupled to the switch S₃. A second end of the main line 910B is coupled to the switch S₅. The line 925B couples the first end of the coupled lines 915B and 920B to the switch S₄. The line 930B couples the second end of the coupled lines 915B and 920B to the switch S₆. As the parallel coupled line coupler has multiple sections, each of the main lines 910A and 910B may be referred to as a main line section, and each of the coupled lines 915A, 920A, 915B, and 920B may be referred to as a coupled line section. As further described herein, the section 905A may be selectively coupled to the section 905B based on a state (e.g., on/closed or off/open state) of the switches S₁ through S₆. As shown in FIG. 9, the layout 900 includes additional routing/extensions to couple the various lines of the sections 905A and 905B to the bumps 805, 810, 815, and/or 820 and/or the switches S₁, S₂, S₃, S₄, S₅, and/or S₆.

With reference to FIGS. 8A and 9, in the first configuration 800 (e.g., mid band operation), the switches S₁ and S₂ are closed and the switches S₃ through S₆ are open. A transmit path from the input port of the parallel coupled line coupler to the output port of the parallel coupled line coupler and coupled paths are provided as follows. An input power provided at the bump 805 associated with the input port is provided to the main line 910A. A power signal propagates through the main line 910A, through the closed switch S₁ (e.g., it is noted the switch S₃ is open), and to the bump 810 associated with the output port. A portion of the power signal propagating through the main line 910A is coupled into the coupled lines 915A and 920A. The line 925A couples a power signal at the first end of the coupled lines 915A and 920A to the bump 815 associated with the coupled port. The line 930A couples a power signal at the second end of the coupled lines 915A and 920A through the closed switch S₂ (e.g., it is noted the switch S₄ is open) and to the bump 820 associated with the isolated port. The section 905B of the parallel coupled line coupler is not coupled to the section 905A. In this regard, the section 905B is deactivated in the first configuration 800. As such, in the first configuration 800, the parallel coupled line coupler may have an effective size (e.g., an effective coupling length, an effective area, etc.) based on a size of the section 905A.

With reference to FIGS. 8B and 9, in the second configuration 850 (e.g., low band operation), the switches S₁ and S₂ are open and the switches S₃ through S₆ are closed. A transmit path from the input port of the parallel coupled line coupler to the output port of the parallel coupled line coupler is provided as follows. An input power provided at the bump 805 associated with the input port is provided to the main line 910A. A power signal propagates through the main line 910A, through the closed switch S₃ (e.g., it is noted the switch S₁ is open) and to the main line 910B of the section 905B. The power signal propagates through the main line 910B, through the closed switch S₅, and to the bump 810 associated with the output port. In this regard, the parallel coupled line coupler operated in the second configuration 850 is associated with larger size than the parallel coupled line coupler operated in the first configuration 800.

A portion of the power signal propagating through the main line 910A is coupled into the coupled lines 915A and 920A and a portion of the power signal propagating through the main line 910B is coupled into the coupled lines 915B and 920B. The line 925A couples a power signal at the first end of the coupled lines 915A and 920A to the bump 815 associated with the coupled port. The line 930A couples a power signal at the second end of the coupled lines 915A and 920A, through the closed switch S₄ (e.g., it is noted the switch S₂ is open), through the line 925B, and to the first end of the coupled lines 915B and 920B. The line 930B couples a power signal at the second end of the coupled lines 915B and 920B through the closed switch S₆ and to the bump 820 associated with the isolated port. As such, the section 905B of the parallel coupled line coupler is coupled to the section 905A. In this regard, the section 905B is activated in the second configuration 850. In the second configuration 850, the parallel coupled line coupler may have an effective size (e.g., an effective coupling length, an effective area, etc.) based on a size of the section 905A and a size of the section 905B. As such, the parallel coupled line coupler in the second configuration 850 is larger than the parallel coupled line coupler in the first configuration 800. In this regard, the parallel coupled line coupler includes the section 905A when configured/operated as a mid band coupler, and includes both the sections 905A and 905B when configured/operated as a low band coupler.

It is noted that FIGS. 8A, 8B, and 9 illustrate an example parallel coupled line coupler that may allow operation in two bands. In some embodiments, a parallel coupled line coupler may have more than two selectable effective sizes (e.g., selectable coupling lengths, selectable area) and allow operation in more than two bands. As an example, the parallel coupled line coupler of FIGS. 8A and 8B may be modified/redesigned to include additional switches, additional more sections, and/or adjust the sections 905A and/or 905B (e.g., such as by dividing the sections 905A and/or 905B into two or more sections using switches) to expand the number of frequency bands that may be accommodated by the parallel coupled line coupler to more than two bands. In some cases, such modification/redesign of the parallel coupled line coupler of FIGS. 8A and 8B may be associated with a change in a position of one or more of the bumps 805, 810, 815, and 820 and one or more of the switches S₁ through S₆ and/or a change in a position, a shape, and/or a size of various lines of the parallel coupled line coupler. Furthermore, although FIGS. 8A, 8B, and 9 are described in relation to a selectable coupler size to facilitate operation in one of two frequency bands, in some embodiments, the selectable coupler size may be to allow different performance characteristics in association with operation in a single frequency band.

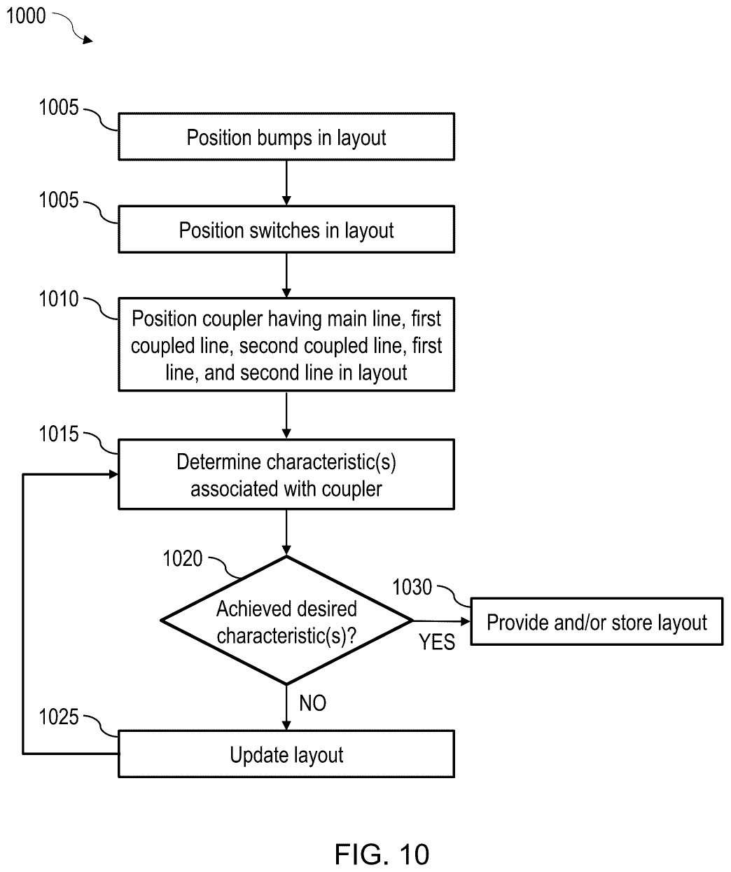

FIG. 10 illustrates a flow diagram of an example process 1000 for designing an IC having a parallel coupled line coupler in accordance with one or more embodiments of the present disclosure. Although the process 1000 is primarily described herein with reference to the layout 900 and associated parallel coupled line coupler of FIG. 9 for explanatory purposes, the process 1000 can be performed in relation to other layouts and other parallel coupled line couplers, such as parallel coupled line couplers associated with operation in a single frequency band or more than two frequency bands. Note that one or more operations in FIG. 10 may be combined, omitted, and/or performed in a different order as desired.

The process 1000 may be associated with an IC design application. In some embodiments, the process 1000 may be performed by a system similar to the system 100 of FIG. 1. In this regard, the system may include a logic device to perform the process 1000 to design an IC. The system may include memory that may store instructions and/or parameters associated with the process 1000, store results (e.g., IC layouts) generated by the process 1000, and so forth. The system may include a control component(s) and/or a display component(s) to receive user input (e.g., keyboard input, mouse input, etc.) and provide a user interface (e.g., associated with the IC design application) and associated feedback to facilitate IC design.

At block 1005, the bumps 805, 810, 815, and 820 are positioned in an IC layout. At block 1010, the switches S₁ through S₆ are positioned in the IC layout. In some cases, such as when design consideration is with respect to a parallel coupled line coupler that operates in a single frequency band and does not have a configurable coupler size, block 1010 may be optional (e.g., the parallel coupled line coupler design may or may not include switches). At block 1015, a parallel coupled line coupler is positioned in the IC layout. In this regard, the main lines 910A and 910B, the coupled lines 915A, 920A, 915B, and 920B, and the lines 925A, 930A, 925B, and 930B that form the parallel coupled line coupler are positioned in the IC layout. The various lines 910A, 910B, 915A, 920A, 915B, 920B, 925A, 930A, 925B, and 930B are positioned as appropriate to couple to one or more of the bumps 805, 810, 815, and 820 and/or one or more of the switches S₁ through S₆. Appropriate routing/extensions may be positioned in the IC layout to allow such coupling between lines, bumps, and/or switches.

At block 1015, a characteristic(s) associated with the parallel coupled line coupler may be determined. By way of non-limiting examples, such a characteristic may include coupling/performance characteristics (e.g., coupling factor, directivity, isolation, insertion loss, a return loss), a size, a manufacturing complexity/cost, and/or others associated with the parallel coupled line coupler.

At block 1020, a determination is made as to whether the parallel coupled line coupler achieves the desired characteristic(s). If the determination at block 1020 is that the parallel coupled line coupler does not achieve the desired characteristic(s), the process 1000 proceeds from block 1020 to block 1025. At block 1025, the IC layout is updated to obtain an updated IC layout. In some cases, updates to the IC layout may include adjusting a position of one or more of the bumps 805, 810, 815, and 820 if possible/allowed, one or more of the switches S₁ through S₆ if possible/allowed, and/or one or more of the lines 910A, 910B, 915A, 920A, 915B, 920B, 925A, 930A, 925B, and 930B. In some cases, updates may include a reshaping and/or a resizing of the parallel coupled line coupler (e.g., through a reshaping and/or a resizing of one or more of the lines 910A, 910B, 915A, 920A, 915B, 920B, 925A, 930A, 925B, and 930B). In some cases, a section of a parallel coupled line coupler (or portion thereof) may be removed, added, and/or adjusted. The process 1000 then proceeds from block 1025 to block 1015, in which block 1015 and 1020 are then performed in association with the updated layout.

If the determination at block 1020 is that the parallel coupled line coupler achieves the desired characteristic(s), the process 1000 proceeds from block 1020 to block 1030. At block 1030, the IC layout that achieves the desired characteristic(s) is provided (e.g., to a system that processes the IC layout) and/or stored. The IC layout may be used to implement an IC having the parallel coupled line coupler, bumps, and switches as arranged in the IC layout. As an example, the resulting IC layout may be the layout 900 of FIG. 9.

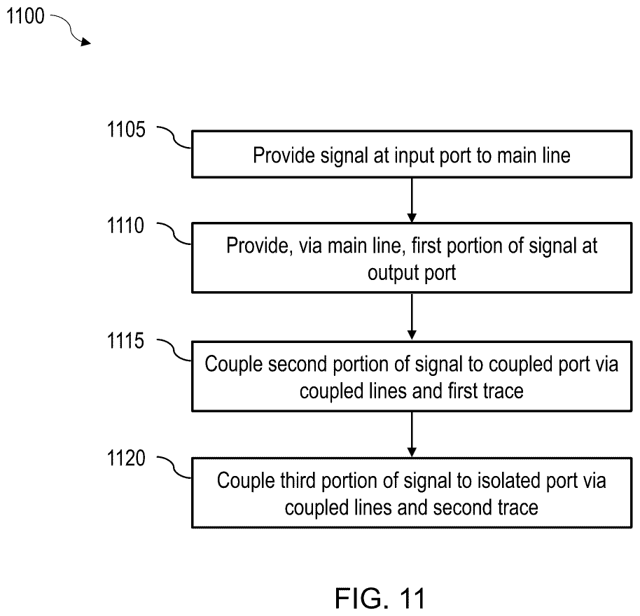

FIG. 11 illustrates a flow diagram of an example process 1100 of operating a parallel coupled line coupler in accordance with one or more embodiments of the present disclosure. For explanatory purposes, the process 1100 is primarily described herein with reference to the parallel coupled line coupler 300 of FIG. 3, although the process 1100 can be performed in relation to other parallel coupled line couplers, such as parallel coupled line couplers having multiple sections selectively coupled to accommodate two or more frequency bands. Note that one or more operations in FIG. 11 may be combined, omitted, and/or performed in a different order as desired.

At block 1105, a signal (e.g., power signal) at the input port of the parallel coupled line coupler 300 is provided to the main line 305. At block 1110, the signal propagates through the main line 305 such that a portion the signal is provided at the output port of the parallel coupled line coupler 300. At block 1115, a portion of the signal propagating through the main line 305 is coupled to the coupled port of the parallel coupled line coupler 300 via the coupled lines 310 and 315 and the line 320. In this regard, the signal propagating through the main line 305 has a component that couples into the coupled lines 310 and 315. The line 320 couples a signal at the first end of the coupled lines 310 and 315 to the coupled port. At block 1120, a portion of the signal propagating through the main line 305 is coupled to the isolated port of the parallel coupled line coupler 300 via the coupled lines 310 and 315 and the line 325. The line 325 couples a signal at the second end of the coupled lines 310 and 315 to the isolated port. As the isolated port is designed to be isolated, the signal at the second end of the coupled lines 310 and 315 is negligible (e.g., ideally/nominally zero power) when the parallel coupled line coupler 300 is properly designed (e.g., according to desired characteristics generally associated with couplers).

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the present disclosure. It should also be understood that numerous modifications and variations are possible in accordance with the principles of the present disclosure. Accordingly, the scope of the invention is defined only by the following claims.

What is claimed is:

1. A coupled line coupler comprising:
an input port;
an output port;
a coupled port;
an isolated port;
a main line coupled between the input port and the output port;
a first coupled line displaced from the main line;
a second coupled line displaced from the main line;
a first line coupled to the first coupled line, the second coupled line, and the isolated port; and
a second line coupled to the first coupled line, the second coupled line, and the coupled port.

2. The coupled line coupler of claim 1, wherein the first coupled line is displaced from the main line along a first direction, and wherein the second coupled line is displaced from the main line along a second direction opposite the first direction.

3. The coupled line coupler of claim 1, wherein each of the main line, the first coupled line, and the second coupled line are substantially parallel to each other when viewed in a top view of the coupled line coupler as each of the main line, the first coupled line, and the second coupled line extends along a length of the coupled line coupler.

4. The coupled line coupler of claim 3, wherein each of the main line, the first coupled line, and the second coupled line forms a respective L-shape or a respective serpentine shape.

5. The coupled line coupler of claim 1, wherein:
the first line is coupled to a first end of the first coupled line, a first end of the second coupled line, and the isolated port; and
the second line is coupled to a second end of the first coupled line, a second end of the second coupled line, and the coupled port.

6. The coupled line coupler of claim 5, wherein the first line is attached to the first end of the first coupled line via a first attachment element, and wherein the second line is attached to the first end of the second coupled line via a second attachment element.

7. The coupled line coupler of claim 5, wherein:
the main line is a first main line section, the first coupled line is a first coupled line section, and the second coupled line is a second coupled line section; and
the coupled line coupler further comprises:
a multi-section main line comprising the first main line section and a second main line section, wherein the second main line section is configured to be selectively coupled to the first main line section and to the output port;
a multi-section first coupled line comprising the first coupled line section and a third coupled line section, wherein the third coupled line section is displaced from the second main line section and is configured to be selectively coupled to the first coupled line section; and
a multi-section second coupled line comprising the second coupled line section and a fourth coupled line section, wherein the fourth coupled line section is displaced from the second main line section and is configured to be selectively coupled to the second coupled line section.

8. The coupled line coupler of claim 7, further comprising:
a third line coupled to a first end of the third coupled line section and a first end of the fourth coupled line section; and
a fourth line coupled to a second end of the third coupled line section and a second end of the fourth coupled line section.

9. The coupled line coupler of claim 7, further comprising a switch circuit configured to:
selectively couple the first main line section to the second main line section based on an adjustable operating frequency band;
selectively couple the first coupled line section to the third coupled line section based on the adjustable operating frequency band; and
selectively couple the second coupled line section to the fourth coupled line section based on the adjustable operating frequency band.

10. The coupled line coupler of claim 1, wherein the first line and the second line are substantially perpendicular to both the first coupled line and the second coupled line.

11. An integrated circuit comprising the coupled line coupler of claim 1, further comprising:
a first bump coupled to the input port;
a second bump coupled to the output port;
a third bump coupled to the isolated port; and
a fourth bump coupled to the coupled port.

12. A device comprising the coupled line coupler of claim 1, the device further comprising:
an amplifier coupled to the input port; and
an antenna coupled to the output port.

13. A method for designing an integrated circuit (IC) having the coupled line coupler of claim 1, the method comprising:
positioning a plurality of bumps in an IC layout; and
positioning each of the main line, the first coupled line, the second coupled line, the first line, and the second line in the IC layout based on a position of each of the plurality of bumps.

14. The method of claim 13, further comprising positioning a plurality of switches on the IC layout, wherein the positioning each of the main line, the first coupled line, the second coupled line, the first line, and the second line is further based on a position of each of the plurality of switches.

15. The method of claim 13, further comprising:
determining one or more performance characteristics associated with the coupled line coupler; and
adjusting, in the IC layout, a position of at least one of the main line, the first coupled line, the second coupled line, the first line, or the second line based on the one or more performance characteristics.

16. A method comprising:
providing a signal to a main line of a coupled line coupler, wherein the main line is coupled between an input port of the coupled line coupler and an output port of the coupled line coupler;
propagating the signal through the main line to provide a first portion of the signal at the output port; and
coupling a second portion of the signal to a coupled port of the coupled line coupler via a first coupled line, a second coupled line, and a first line of the coupled line coupler, wherein the first and second coupled lines are displaced from the main line, wherein the first line is coupled to the first coupled line, the second coupled line, and the coupled port.

17. The method of claim 16, wherein each of the main line, the first coupled line, and the second coupled line are substantially parallel to each other when viewed in a top view of the coupled line coupler as each of the main line, the first coupled line, and the second coupled line extends along a length of the coupled line coupler.

18. The method of claim 16, further comprising coupling a third portion of the signal to an isolated port of the coupled line coupler via the first coupled line, the second coupled line, and a second line of the coupled line coupler, wherein the second line is coupled to the first coupled line, the second coupled line, and the isolated port.

19. The method of claim 18, wherein:
the main line is a first main line section, the first coupled line is a first coupled line section, and the second coupled line is a second coupled line section; and
the method further comprises:
selectively coupling the first main line section to a second main line section of the coupled line coupler;
selectively coupling the first coupled line section to a third coupled line section of the coupled line coupler, wherein the third coupled line section is displaced from the second main line section; and
selectively coupling the second coupled line section to a fourth coupled line section of the coupled line coupler, wherein the fourth coupled line section is displaced from the second main line section, and wherein a first end of the third and fourth coupled line sections are coupled together by a third line of the coupled line coupler and a second end of the third and fourth coupled line sections are coupled together by a fourth line of the coupled line coupler.

20. The method of claim 19, wherein the selectively coupling the first main line section, the selectively coupling the first coupled line section, and the selectively coupling the second coupled line section are based on an adjustable operating frequency band.
